(19) United States
(12) Patent Application Publication
(10) Pub. No.: US 2010/0177002 A1
(43) Pub. Date: Jul. 15, 2010

(54) DIPOLE ANTENNA

(75) Inventors: Chang-Jung Lee, Taoyuan County (TW); Jian-Jhih Du, Taipei City (TW)

Correspondence Address: RABIN & Berdo, PC, 1101 14TH STREET, NW, SUITE 500, WASHINGTON, DC, 20005, US

(73) Assignee: Arcadyan Technology Corporation, Hsinchu (TW)

(21) Appl. No.: 12/648,664

(22) Filed: Dec. 29, 2009

(30) Foreign Application Priority Data
Jan. 10, 2009 (TW) 098100862

(51) Int. Cl. H01Q 9/28; H01Q 1/48

(52) U.S. Cl. 343/795; 343/807; 343/846

(57) ABSTRACT

The antenna includes a substrate, a radiation part and a ground part. The radiation part is disposed on the substrate. The outside frame of the radiation part is similar to D-type. The radiation part has at least a hole inside. The ground part is also disposed on the substrate. The ground part has at least a hole inside. Positions of a feeding terminal and a ground terminal of the antenna are not limited to center regions of the sides of the radiation part and the ground part.

This application claims the benefit of Taiwan application Serial No. 98100862, filed Jan. 10, 2009, the subject matter of which is incorporated herein by reference.

### BACKGROUND OF THE INVENTION

1. Field of the Invention

The invention relates in general to an antenna, and more particularly to a D-type dipole antenna.

2. Description of the Related Art

Along with the rapid advance in science and technology, various slim and compact antennas are provided and used in various slim and compact hand-held electronic devices (such as mobile phone or notebook computer) or wireless communication devices (such as AP (Access Point)). For example, the slim and compact dipole antenna has excellent transmission performance and can be easily disposed on the inner-wall of a hand-held electronic device, has been used in wireless transmission of a large variety of hand-held electronic devices or in wireless communication device.

Due to the design of the conventional dipole antenna, the oscillation frequency is hard to change and the bandwidth is hard to increase. Moreover, the volume is hard to reduce, the low frequency performance is poor, and the range of application is limited.

### SUMMARY OF THE INVENTION

The invention is directed to a D-type dipole antenna featured by broadband and omni-direction. By the positions of the feeding terminal and the ground terminal, the antenna has features of increased bandwidth, small size, excellent low-frequency performance and high application.

An example of the present invention provides a D-type dipole antenna including a substrate, a radiation part and a ground part. The radiation part is disposed on the substrate. The radiation part has a top edge and a bevel edge, wherein the bevel edge is connected to the top edge so that the outside frame of the radiation part is similar to D-type for increasing the operating bandwidth of the antenna. The radiation part has at least a first hole inside. The radiation part includes a feeding terminal for transmitting and feeding a signal, wherein the feeding terminal is disposed at the top edge of the radiation part. The ground part and the radiation part are co-planarly disposed on the substrate. The ground part has a top edge. There is a gap between the top edge of the ground part and the top edge of the radiation part, wherein the top edge of the ground part and the top edge of the radiation part are opposite to each other. The ground part has at least a second hole inside, wherein the second hole has a bevel edge adjacent to neither the top edge nor the bottom edge of the ground part, so that the shape of the second hole is similar to D-type. The first hole and the second hole increase the operating bandwidth of the antenna and adjust the impedance matching of the antenna. The ground part includes a ground terminal for grounding the antenna. The ground terminal is adjacent to the feeding terminal and disposed at the top edge of the ground part. The positions of the feeding terminal and the ground terminal are flexible, and can be disposed at the top edge of the radiation part corresponding to the top edge of the ground part for effectively increasing the operating bandwidth of the antenna according to the needs in the operating bandwidth of the antenna.

Wherein, the bevel edge of the radiation part or the bevel edge of the second hole can be a straight line, an arc or an irregular shape, so that the shape of the radiation part or the second hole is D-type or similar to D-type.

Wherein, the shape of the first hole can be a rectangle, a polygon, an arc, or D-type.

Wherein, the shape of the first hole is identical to that of the radiation part and all edges of the first hole are at substantially the same distance to the outside frame of the radiation part.

Wherein, the feeding terminal is disposed at the top edge of the radiation part, which is farthest away from the bevel edge of the radiation part.

Wherein, the radiation part further includes a bottom edge, wherein the top edge and the bottom edge are opposite to each other and connected by two ends of the bevel edge respectively, so that the operating frequency of the antenna is adjusted by changing the distance between the top edge and the bottom edge of the radiation part.

Wherein, the top edge and the bottom edge of the radiation part are opposite and parallel to each other.

Wherein, the ground part further has a bottom edge opposite to the top edge, so that the operating frequency of the antenna is adjusted by changing the distance between the top edge and the bottom edge of the radiation part.

Wherein, the top edge and the bottom edge of the ground part are opposite and parallel to each other.

The invention will become apparent from the following detailed description of the preferred but non-limiting embodiments. The following description is made with reference to the accompanying drawings.

### BRIEF DESCRIPTION OF THE DRAWINGS

FIG. 1 shows an antenna structure diagram of a first embodiment of the invention;

FIG. 2 shows a standing wave ratio diagram of the antenna of the first embodiment of the invention;

FIG. 3A˜3J show vertical polarization gain field of the antenna of the first embodiment of the invention;

FIGS. 4A˜4J show horizontal polarization gain field of the antenna of the first embodiment of the invention;

FIG. 5 shows an antenna structure diagram of a second embodiment of the invention; and

FIG. 6 shows an antenna structure diagram of a third embodiment of the invention.

### DETAILED DESCRIPTION OF THE INVENTION

Embodiments of the invention provide a D-type dipole antenna including a substrate, a radiation part and a ground part. The D-type dipole antenna has an inside hole so that the antenna has the features of broadband and omni-direction. Position of the feeding terminal and the ground terminal of the antenna is not limited at respective central region of top edges of the radiation part and the ground part. The antenna has features of increased bandwidth, small size, excellent low-frequency performance and high application.

### First Embodiment

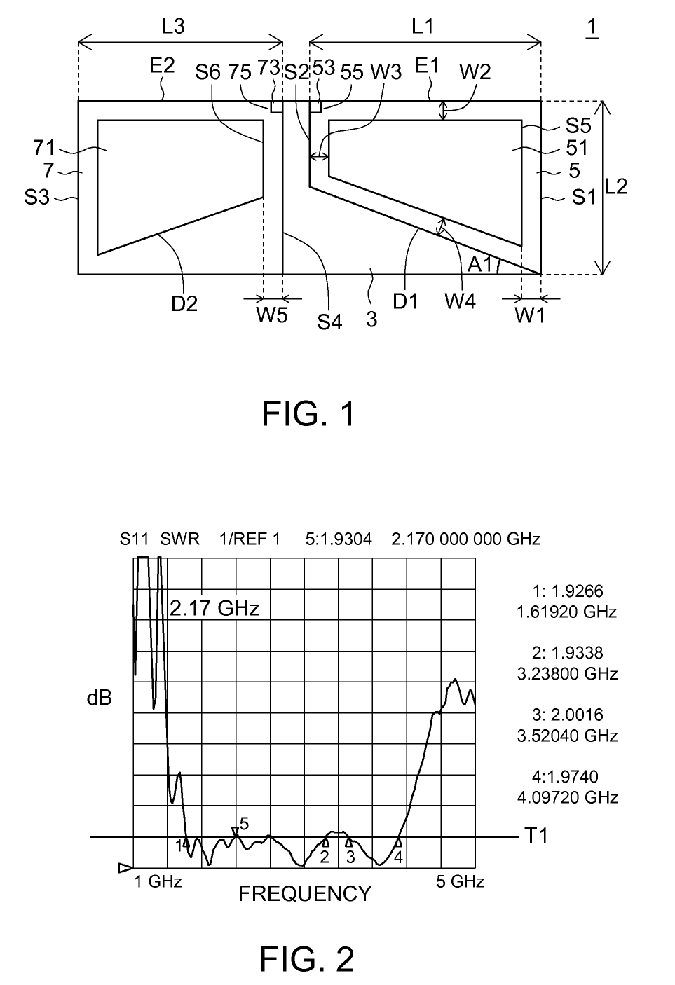

Referring to FIG. 1, an antenna structure diagram of a first embodiment of the invention is shown. The antenna 1, which can be used in wireless communication devices, supports Institute of Electrical and Electronic Engineers (IEEE) 802.11b/g standard, Worldwide Interoperability for Microwave Access (WIMAX), Digital Enhanced Cordless Telecommunications (DECT), Universal Mobile Telecommunications System (UMTS) wherein respective bandwidth for 802.11b/g, WIMAX, DECT and UMTS are 2.4 GHz˜2.5 GHz, 2.3 GHz˜2.7 GHz, 1.8 GHz˜1.9 GHz, and 1.92 GHz˜2.17 GHz. That is, the antenna 1 of the first embodiment of the invention can be operated within 1.8 GHz˜2.7 GHz.

The antenna 1 includes a substrate 3, a radiation part 5 and a ground part 7. The substrate 3 is made from flexible substrate, printed circuit board, or high dielectric coefficient circuit board. The radiation part 5 is disposed on the surface of the substrate 3. The outside frame of the radiation part 5 includes a first edge E1, a bottom edge S1, a top edge S2 and a bevel edge D1, wherein the top edge S2 and the bottom edge S1 are opposite to each other. For example, the top edge S2 and the bottom edge S1 of the radiation part 5 may be opposite and parallel to each other. The top edge S2 is connected to the bottom edge S1 and the bevel edge D1. The radiation part 5 includes a first hole 51 and a feeding terminal 53, wherein the feeding terminal 53 is disposed at the top edge S2 of the radiation part 5.

Two ends of the bevel edge D1 of the radiation part 5 are respectively connected to the top edge S2 and the bottom edge S1, so that the operating frequency of the antenna is adjusted by changing a distance L1 between the top edge S2 and the bottom edge S1. The shape of the bevel edge D1 can be a straight line, an arc or an irregular shape, so that the shape of the outside frame of the radiation part is a D-type, a similar D-type, a similar D-type with an arc or a similar D-type with an irregular edge.

The shape of the first hole 51 can be a D-type, a similar D-type, a rectangle, an arc, a trapezoid, a quadrilateral, a polygon or any shape having more than four laterals. In FIG. 1, the radiation part 5 has a single hole 51. However, in other embodiments of the invention, the radiation part 5 can have a plurality of holes for increasing bandwidth.

In FIG. 1, the feeding terminal 53 is located at but not limited to the top edge S2 of the radiation part 5. For example, in other embodiments of the invention, the position range of the feeding terminal 53 is substantially within ⅓ of the length L2 of the bottom edge S1. For example, the feeding terminal 53 is located at a position of the top edge S2 of the radiation part 5, which is farthest away from the bevel edge D1 of the radiation part 5.

The ground part 7 is disposed on the surface of the substrate 3. For example, both the ground part 7 and the radiation part 5 are disposed on the same plane. The outside frame of the ground part 7 includes a second edge E2, a bottom edge S3 and a top edge S4. The top edge S4 and the bottom edge S3 of the outside frame of the ground part 7 are opposite to each other. For example, the top edge S4 and the bottom edge S3 of the outside frame of the ground part 7 are opposite and parallel to each other, so that the operating frequency of the antenna is adjusted by changing a distance L3 between the top edge S4 and the bottom edge S3 of the outside frame of the ground part 7.

A gap is formed between the top edge S4 of the outside frame of the ground part 7 and the top edge S2 of the radiation part 5, wherein the top edge S4 of the ground part 7 and the top edge S2 of the radiation part 5 are opposite to each other.

The ground part 7 includes a second hole 71 and a ground terminal 73, wherein the second hole 71 has a bevel edge D2 neither adjacent to the top edge S4 nor the bottom edge S3 of the outside frame of the ground part 7. For example, the bevel edge D2 of the second hole 71 of the ground part 7 can be a straight line, an arc or an irregular shape. The bevel edge D2 of the second hole 71 makes the shape of the second hole a D-type, a similar D-type, a similar D-type shape with an arc, or a similar D-type shape with an irregular edge. However, allocation of the first hole 51 and the second hole 71 increases the operating bandwidth of the antenna and adjusts impedance match of the antenna. Besides, the shapes of the radiation part 5 and the ground part 7 can be the same or different.

The second hole 71 of the ground part 7 can be a D-type shape, an arc, a rectangle, a trapezoid, a quadrilateral and any shape having more than four laterals. In FIG. 1, the ground part 7 has a single hole 71 inside. In other embodiments of the invention, the ground part 7 can have a plurality of holes for increasing the bandwidth.

As indicated in FIG. 1, the ground terminal 73 is disposed at the top edge S4 of the outside frame of the ground part 7 and adjacent to the feeding terminal 53 of the radiation part 5. However, the positions of the ground terminal 73 and the feeding terminal 53 and are not limited thereto. The positions of the feeding terminal 53 and the ground terminal 73 can be adjusted based on the required operating bandwidth of the antenna. For example, the feeding terminal 53 is disposed at the top edge S2 of the outside frame of the radiation part 5, and the ground terminal 73 is disposed at the top edge S4 of the outside frame of the ground part 7, so that the operating bandwidth of the antenna 1 can be effectively increased. For example, the feeding terminal 53 is disposed at a position of the top edge S2 of the radiation part 5, which is farthest away from the bevel edge D1 of the radiation part 5.

In other embodiments of the invention, the position range of the ground terminal 73 is smaller than or equal to ⅓ of the length L2 of the bottom edge S1 of the radiation part 5.

The distance L1 between the bottom edge S1 and the top edge S2 of the outside frame of the radiation part 5 is substantially equal to the distance L3 between the bottom edge S3 and the top edge S4 of the ground part 7. For example, L1≈L3≈0.1λ˜0.3λ, wherein λ denotes the wavelength.

There is a distance W1 between the bottom edge S1 of the outside frame of the radiation part 5 and the bottom edge S5 of the inside frame thereof, wherein W1≈0.05λ˜0.1λ. For example, all edges of the first hole 51 are in the same distance from the outside frame of the radiation part 5. Referring to FIG. 1, W2=W3=W4=W1, wherein, W2˜W4 respectively denote the distance between the radiation part 5 and the first hole 51. Further, the shape of the first hole 51 and the shape of the outside frame of the radiation part 5 may be substantially the same.

There is a distance W5 between the top edge S4 of the outside frame of the ground part 7 and the top edge S6 of the inside frame thereof, wherein W5≈0.05λ˜0.2λ.

The length L3 of the bottom edge S1 of the radiation part 5 ranges between 0.2λ˜0.5λ.

The distance L1 between the bottom edge S1 and the top edge S2 of the radiation part 5 determines the oscillation frequency of the antenna 1. Through appropriate design of the distance L1 between the bottom edge S1 and the top edge S2 of the radiation part 5, the antenna 1 can provide required bandwidth to wireless communication products applying the same. Besides, as for the radiation part 5, the bandwidth of the antenna 1 can be fine tuned or increased by adjusting the horizontal angle A1 of the bevel edge D1 of the radiation part 5.

The feeding terminal 53 is disposed at a position of the top edge S2 of the radiation part 5 of the antenna 1, which is farthest away from the bevel edge D1, rather than disposed at the central regions of the top edge S2 of the radiation part 5, so that the bandwidth of the antenna is increased, the low frequency performance is improved, the antenna is small size, and the application of antenna is enhanced.

Referring to FIG. 2, a standing wave ratio (SWR) diagram of the antenna 1 of the first embodiment of the invention is shown. According to the reference line T1 representing the standing wave ratio equals 2 in the first embodiment of the invention, the first communication band of the antenna 1 ranges 1.61 GHz˜2.17 GHz, the second communication band ranges 2.22 GHz˜3.23 GHz and the third communication band ranges 3.52 GHz˜4.09 GHz. Therefore, the antenna of the first embodiment of the invention is broadband.

The first band includes communication band defined by the DECT and the UMTS. The second band includes communication band defined by the communication protocol 802.11 b/g and the WiMAX. The SWR values at frequencies of 1.61 GHz, 3.23 GHz, 3.52 GHz, 4.09 GHz and 2.17 GHz, denoted by measuring points 1˜5 in FIG. 2, are 1.9265, 1.9338, 2.0016, 1.9740 and 1.9304, respectively. The antenna of the first embodiment of the invention has broadband and effectively supports the communication protocol 802.11 b/g, the UMTS, the DECT and the WiMAX.

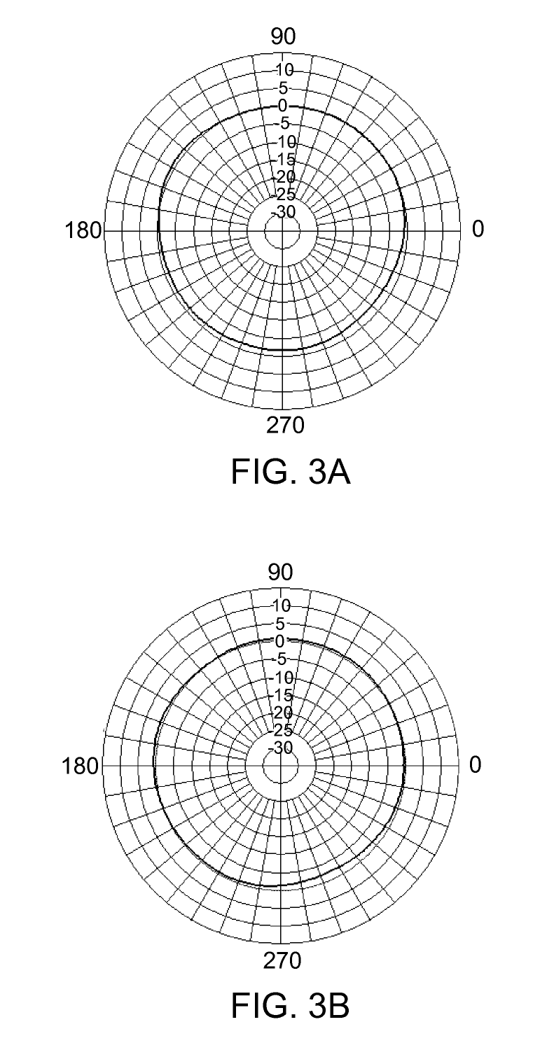

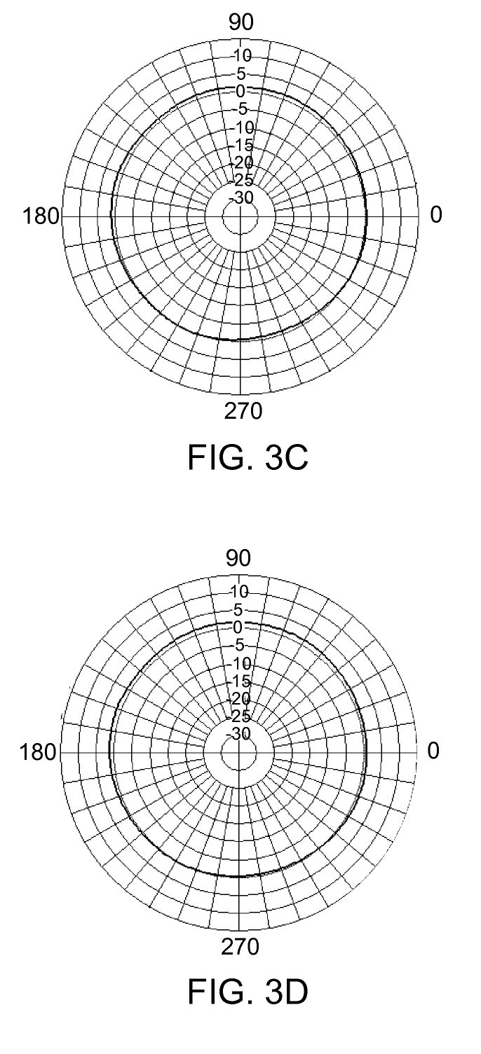

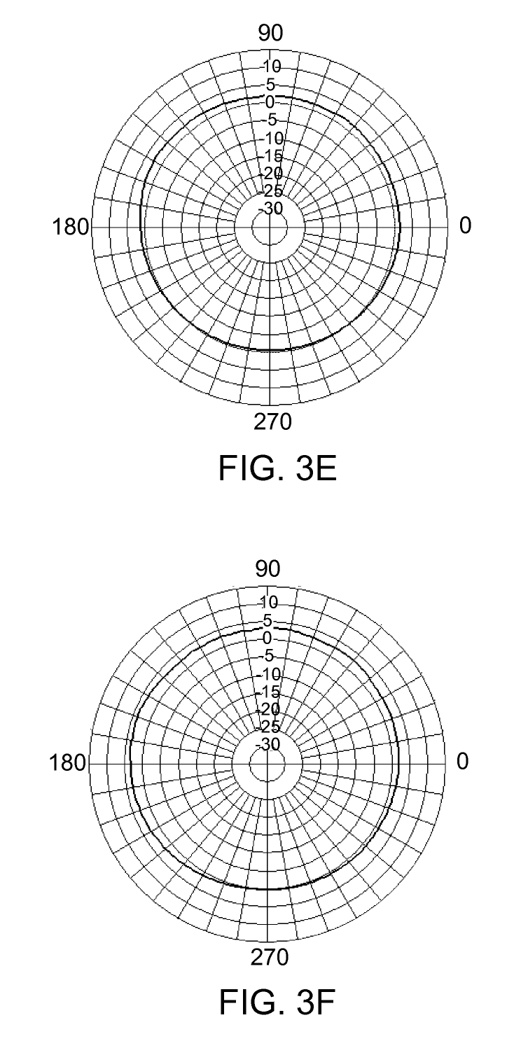

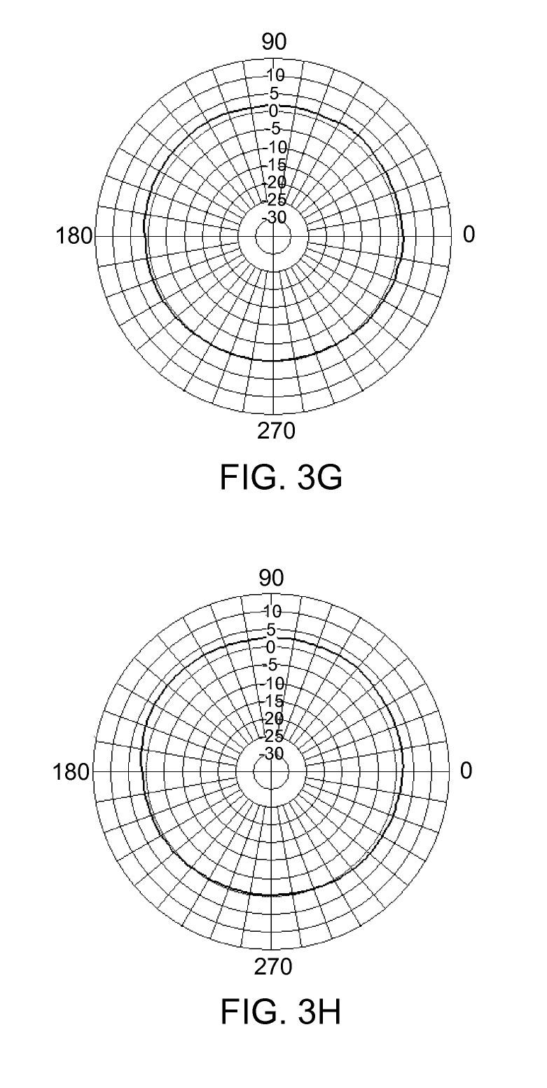

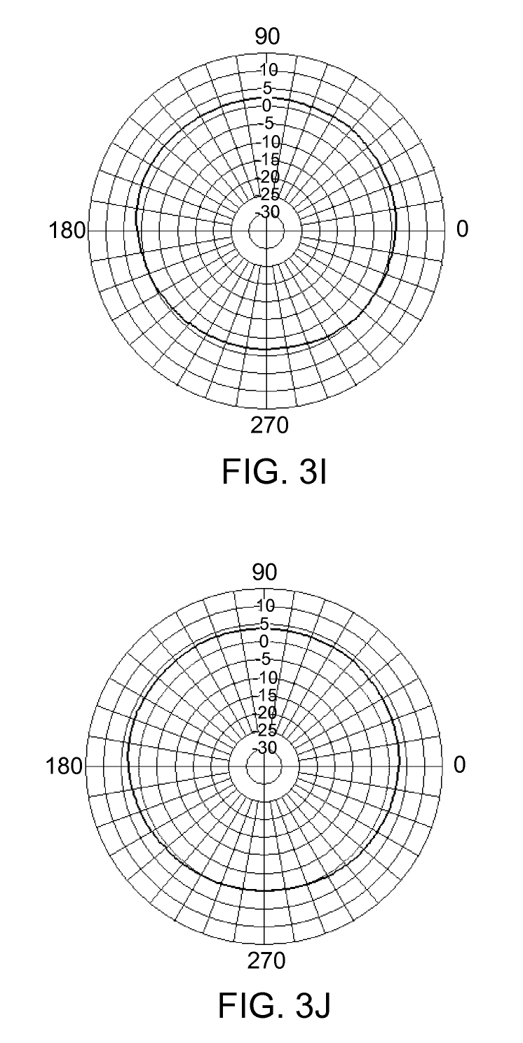

Referring to FIGS. 3A˜3J, vertical polarization gain field of the antenna of the first embodiment of the invention are shown. FIGS. 3A˜3E are vertical polarization gain fields when the antenna is operated at the frequency of 1.8 GHz, 1.88 GHz, 1.9 GHz, 1.92 GHz, 2.17 GHz, respectively. FIGS. 3F˜3J are the vertical polarization gain fields when the antenna is operated at the frequency of 2.3 GHz, 2.45 GHz, 2.5 GHz, 2.6 GHz and 2.7 GHz, respectively. From the vertical polarization gain field, the antenna 1 is omni-direction. Maximum gain and average gain of the vertical polarization are summarized in a table below.

| Frequency (GHz) | 1.8 | 1.88 | 1.9 | 1.92 | 2.17 | 2.3 | 2.45 | 2.5 | 2.6 | 2.7 |
|---|---|---|---|---|---|---|---|---|---|---|
| Maximum Gain (dBi) | 0.88 | 0.75 | 1.32 | 1.58 | 2.14 | 3.63 | 1.98 | 2.82 | 2.42 | 3.73 |
| Average Gain (dBi) | −0.71 | −0.25 | 0.48 | 0.71 | 1.07 | 2.14 | 0.99 | 1.5 | 0.87 | 2.42 |

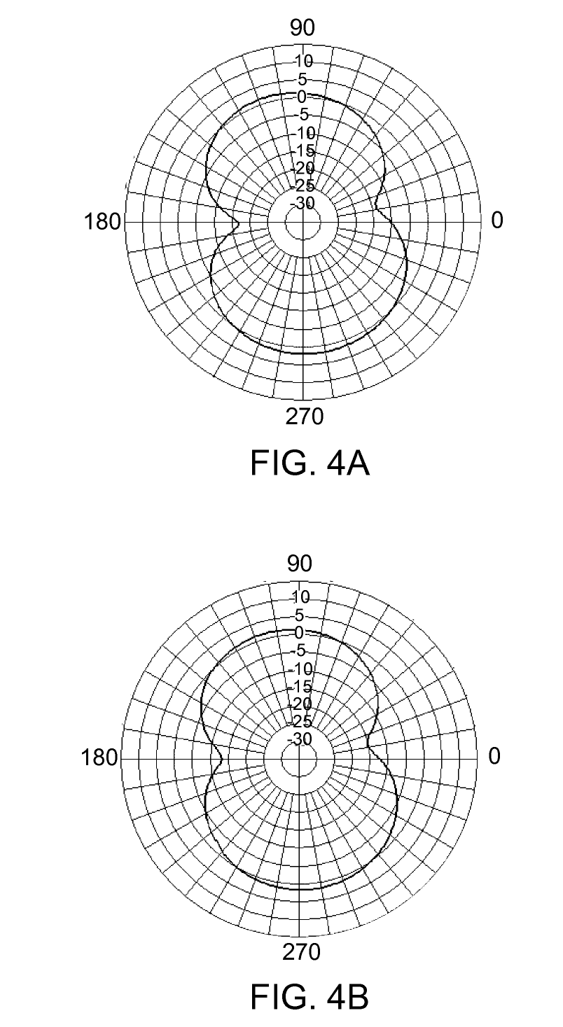

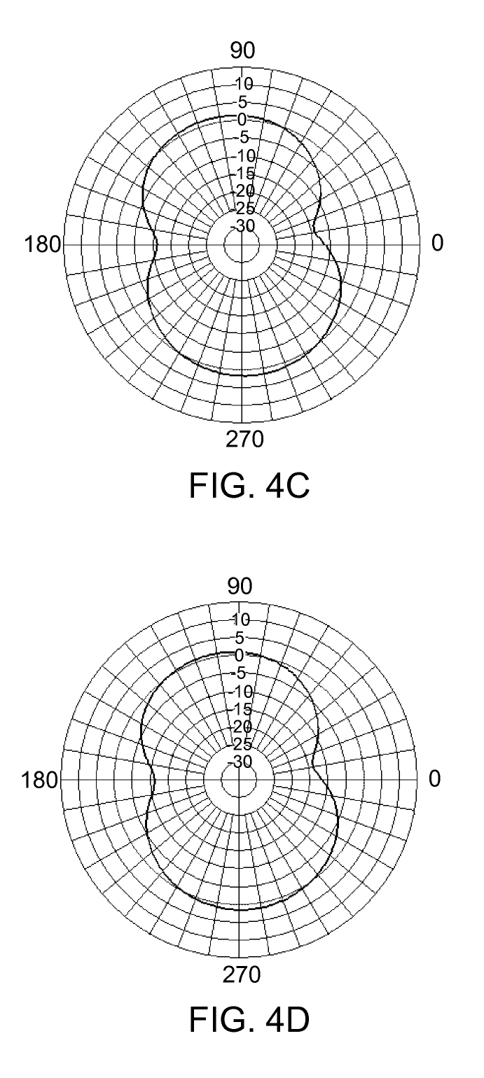

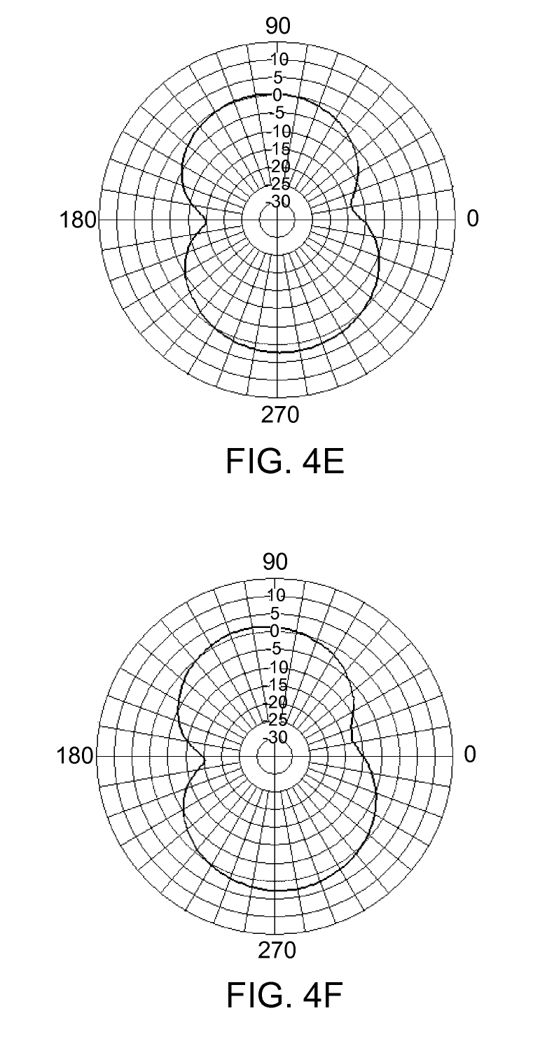

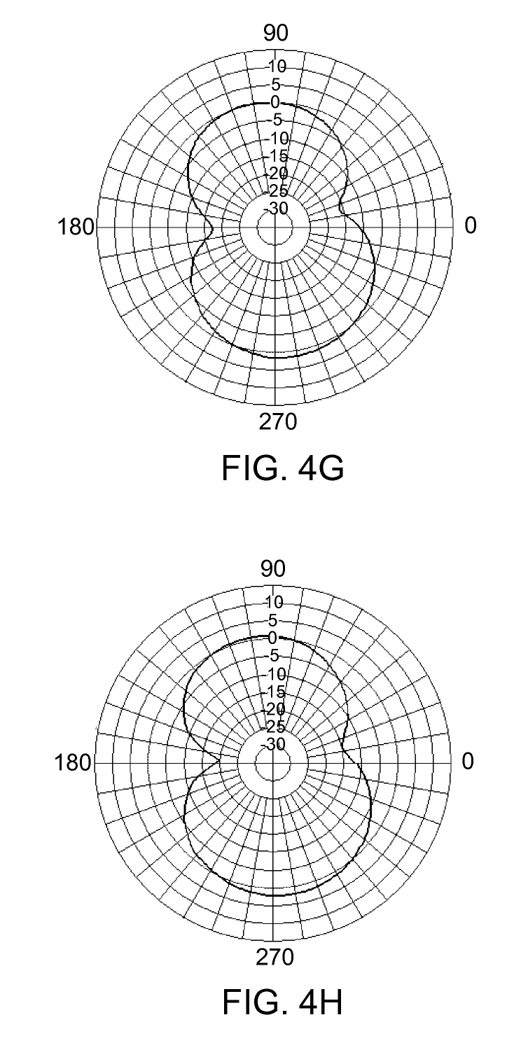

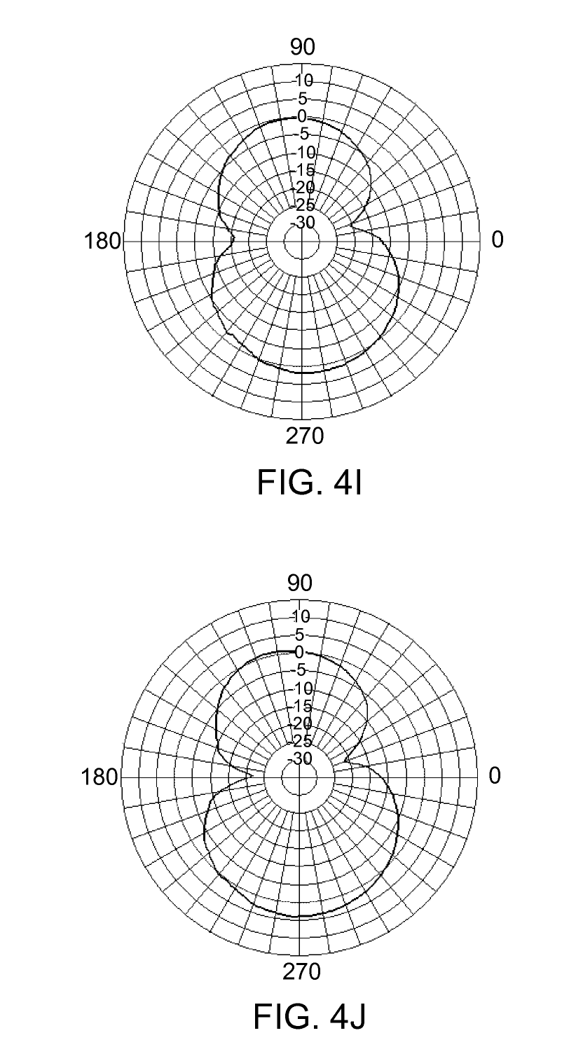

Referring to FIGS. 4A˜4J, horizontal polarization gain fields of the antenna of the first embodiment of the invention are shown. FIG. 4A˜4E are the horizontal polarization gain fields when the antenna is operated at frequencies of 1.8 GHz, 1.88 GHz, 1.9 GHz, 1.92 GHz, 2.17 GHz, respectively. FIG. 4F˜4J are the horizontal polarization gain fields when the antenna is operated at frequencies of 2.3 GHz, 2.45 GHz, 2.5 GHz, 2.6 GHz and 2.7 GHz, respectively. Maximum gain and average gain of the horizontal polarization are summarized in a table below.

| Frequency (GHz) | 1.8 | 1.88 | 1.9 | 1.92 | 2.17 | 2.3 | 2.45 | 2.5 | 2.6 | 2.7 |
|---|---|---|---|---|---|---|---|---|---|---|
| Maximum Gain (dBi) | 1.87 | 1.55 | 1.64 | 1.42 | 2.17 | 2.65 | 1.48 | 2.05 | 1.78 | 3.91 |
| Average Gain (dBi) | −1.4 | −1.67 | −1.62 | −1.97 | −1.79 | −1.32 | −2.67 | −2.13 | −2.92 | −1.37 |

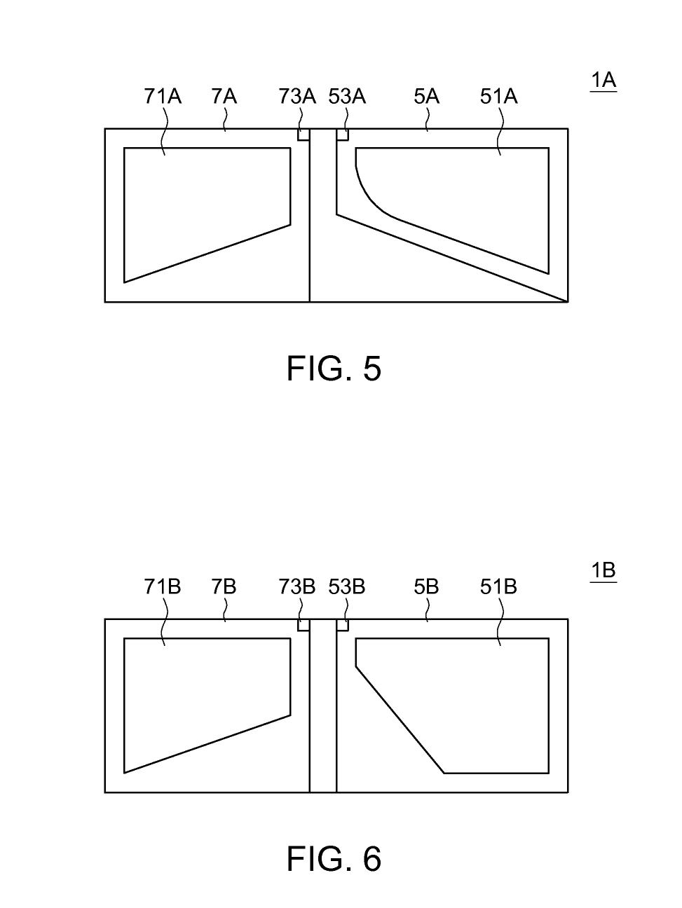

Referring to FIG. 5, an antenna structure diagram of a second embodiment of the invention is shown. Compared with the first embodiment of the invention, in the second embodiment, the shape of the first hole 51A of the antenna 1A is an arc. Besides, the radiation part 5A and the ground part 7A of the second embodiment are identical or similar to the radiation part 5 and the ground part 7 of the first embodiment. The position range of the feeding terminal 53A and the ground terminal 73A is substantially identical or similar to that of the feeding terminal 53 and the ground terminal 73 of the first embodiment. The second hole 71A is substantially identical or similar to the second hole 71 of the first embodiment.

Referring to FIG. 6, an antenna structure diagram of a third embodiment of the invention is shown. Compared with the first embodiment of the invention, in the third embodiment, the shape of the first hole 51B of the antenna 1B is a pentagon. Besides, the radiation part 5B and the ground part 7B of the third embodiment are identical or similar to the radiation part 5 and the ground part 7 of the first embodiment. The position range of the feeding terminal 53B and the ground terminal 73B is substantially identical or similar to that of the feeding terminal 53 and the ground terminal 73 of the first embodiment. The second hole 71B is substantially identical or similar to the second hole 71 of the first embodiment.

In the above embodiments of the invention, the shape of the first hole of the radiation part is a D-type and the shape of the second hole of the ground part is a D-type for example. However, the shapes of the first hole and the second hole are not limited to a D-type or a similar D-type, and can be a rectangle, an arc, a quadrilateral or a polygon having more than four laterals. Also, the shape of the outside frames of the radiation part and the ground part can be an oblong, a square, an arc, a rectangle, or a D-type. The shape of the bevel edge of the radiation part is not limited to a straight line, and can also be an arc or an irregular shape, so that the shape of the outside frame of the radiation part is a D-type or a similar to D-type. Besides, the shape of the outside frame of the ground part can also be a D-type or a similar D-type.

The antenna disclosed in the above embodiments of the invention has features of wide bandwidth, small size, excellent low-frequency performance and high application. Also, according to the radiation fields, the antenna disclosed in the above embodiments of the invention is omni-direction and can be more effectively used in wireless communication products.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An antenna, comprising;
a substrate;
a radiation part disposed on the substrate, wherein the radiation part has a top edge and a bevel edge connected to the top edge, so that a shape of an outside frame of the radiation part is a similar D-type, the radiation part has at least a first hole inside, and a feeding terminal is disposed at the top edge of the radiation part for transmitting and feeding a signal; and
a ground part co-planarly disposed on the substrate with the radiation part, wherein the ground part has a top edge opposite to the top edge of the radiation part, the ground part has at least a second hole inside, the second hole has a bevel edge, so that a shape of the second hole is a similar D-type, and a ground terminal adjacent to the feeding terminal is disposed at the top edge of the ground part for grounding the antenna.

2. The antenna according to claim 1, wherein the shape of the outside frame of the radiation part is a D-type, a similar D-type shape with an arc or a similar D-type with an irregular edge.

3. The antenna according to claim 1, wherein the shape of the first hole of the radiation part is a D-type, a similar D-type, an arc, a trapezoid, a quadrilateral or a polygon having more than four laterals.

4. The antenna according to claim 1, wherein the shape of the first hole is identical to that of the outside frame of the radiation part, and all edges of the first hole are at substantially the same distance to the outside frame of the radiation part.

5. The antenna according to claim 1, wherein the second hole of the ground part is a D-type, a similar D-type, an arc, a trapezoid, a quadrilateral or a polygon having more than four laterals.

6. The antenna according to claim 1, wherein the radiation part further has a bottom edge, the ground terminal of the ground part is positioned in a range smaller than or equal to ⅓ of a length of the bottom edge of the radiation part.

7. The antenna according to claim 1, wherein the radiation part and the ground part respectively have a plurality of holes for increasing bandwidth of the antenna.

8. The antenna according to claim 1, wherein the bevel edge of the second hole has a horizontal angle for fine tuning or increasing antenna bandwidth of the antenna.

9. The antenna according to claim 1, wherein the feeding terminal is disposed at the top edge of the radiation part, which is farthest away from the bevel edge of the radiation part.
